(19) United States
(12) Patent Application Publication
(10) Pub. No.: US 2013/0047102 A1
(43) Pub. Date: Feb. 21, 2013

(54) METHOD FOR BROWSING AND/OR EXECUTING INSTRUCTIONS VIA INFORMATION-CORRELATED AND INSTRUCTION-CORRELATED IMAGE AND PROGRAM PRODUCT

(71) Applicants: Tzan-Sheng Yang, Taipei (TW); Hung-Nien Tan, Taipei (TW)

(72) Inventors: Tzan-Sheng Yang, Taipei (TW); Hung-Nien Tan, Taipei (TW)

(73) Assignee: Newsoft Technology Corporation a Taiwan Corporation, Taipei (TW)

(21) Appl. No.: 13/298,078

(22) Filed: Nov. 16, 2011

(30) Foreign Application Priority Data
Aug. 19, 2011 (TW) 100129757

(51) Int. Cl. G06F 17/00

(52) U.S. Cl. 715/764

(57) ABSTRACT

The invention relates to a method for browsing and/or executing instructions via information-correlated and instruction-correlated image. The method includes following steps: interpreting each image block in an image displayed in an image display area of a display interface and establishing information correlated with each image block; browsing or selecting the image block with the correlated information in the image; displaying the correlated information of the selected image block in a correlated information display area of the display interface, and if the information has one or more correlated functional instructions, displaying the functional options of the one or more functional instructions; and if one or more correlated functional instructions are available to be executed, selecting and executing at least one of the functional instructions in the functional options.

### CLAIM OF PRIORITY

This application claims the priority benefit of Taiwan application serial no. 100129757, filed on Aug. 19, 2011. All disclosure thereof is incorporated herein by reference.

### BACKGROUND OF THE INVENTION

A. Field of this Invention

This invention relates to a method and program product thereof for browsing and/or executing instructions via information-correlated and instruction-correlated image.

B. Description of the Relevant Art

Existing mobile devices can take advantage of conventional image processing technology to recognize letters and numerals from information inside an image. However, because of the limitation of display devices, it is difficult to simultaneously display and browse the image and the interpreted information in real time, or to further execute corresponding functions. For instance, utilizing current image processing technology to recognize the letters and numerals, such as telephone number, e-mail address, Web address, and so on, in a business card, mobile devices with restricted display interface cannot easily display the image of the business card and allow users to browse/search included information concurrently.

### SUMMARY OF THE INVENTION

One embodiment of this invention is to provide a method for browsing and/or executing instructions via information-correlated and instruction-correlated image. The method includes following steps: interpreting each image block in an image displayed in an image display area of a display interface and establishing information correlated with each image block; browsing or selecting the image block with the correlated information in the image; displaying the correlated information of the selected image block in a correlated information display area of the display interface, and if the information has one or more correlated functional instructions, displaying the functional options of the one or more functional instructions; and if one or more correlated functional instructions are available to be executed, selecting and executing at least one of the functional instructions in the functional options.

Another embodiment of this invention is to provide a method for browsing and/or executing instructions via information-correlated and instruction-correlated image. The method includes following steps: manually enclosing each image block in an image displayed in an image display area of a display interface and establishing information correlated with each image block; browsing or selecting the image block with the correlated information in the image; displaying the correlated information of the selected image block in a correlated information display area of the display interface, and if the information has one or more correlated functional instructions, displaying the functional options of the one or more functional instructions; and if one or more correlated functional instructions are available to be executed, selecting and executing at least one of the functional instructions in the functional options.

Yet another embodiment of this invention is to provide a program product for browsing and/or executing instructions via information-correlated and instruction-correlated image. A program execution device can perform the method for browsing and/or executing instructions via information-correlated and instruction-correlated image after loading the program product.

Nevertheless, this invention is not limited to the application to business cards. For example, this invention can also be applied in warehouse management and/or other occasions which require browsing and/or executing instructions via information-correlated and instruction-correlated images.

Generally speaking, the term “method for browsing and/or executing instructions via information-correlated and instruction-correlated image” in the specification of this invention means: interpreting or enclosing each image block in an image displayed in an image display area of a display interface; then establishing information correlated with those image blocks (the information correlated with those image blocks includes contents, categories, and corresponding coordinate ranges) to generate so-called “information-correlated and instruction-correlated image”; then, when a user selects an image block, which contains the correlated information, from the image (namely “information-correlated and instruction-correlated image”), displaying the correlated information of the selected image block in a correlated information display area of the display interface, and further executing one or more functional instructions correlated to the selected image block. The technology of correlating the functional instructions with the image block is well-known to those with ordinary skill in the art, therefore the principle of the technology is not further described herein. Further, for example, the one or more functional instructions correlated with the image block described above may be functional instructions pre-defined or afterward user-defined on the program execution device.

Other aspects and advantages of this invention will become apparent from the following detailed description in conjunction with the appended figures. Moreover, in order not to obscure this invention, well-known elements and principles will not be described in the specification.

### BRIEF DESCRIPTION OF THE DRAWINGS

In the appended drawings of this invention, the same reference numerals indicate the same components:

FIG. 1 depicts a flowchart of the method for browsing and/or executing instructions via information-correlated and instruction-correlated image according one embodiment of this invention;

FIG. 2 depicts a flowchart of the method for browsing and/or executing instructions via information-correlated and instruction-correlated image according another embodiment of this invention;

FIG. 3 illustrates an embodiment of this invention applying to business cards; and

FIG. 4 is a schematic view of displaying a correlated information display area on the display interface.

### DETAILED DESCRIPTION OF THE PREFERRED EMBODIMENTS

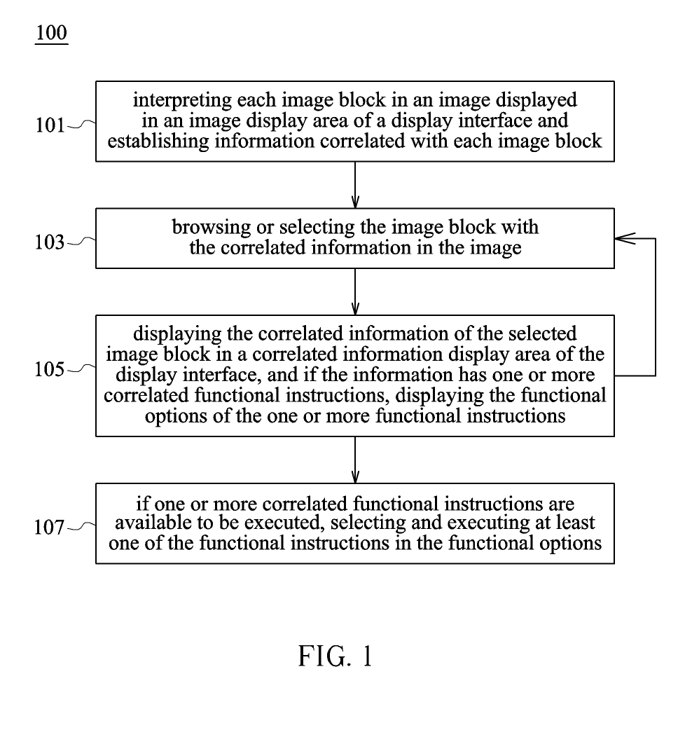

Referring to FIG. 1, flowchart 100 starts from step 101, in which each image block in an image displayed in an image display area of a display interface is interpreted and information correlated with each image block is established. The information correlated with each image block includes contents, categories, and corresponding coordinate ranges. For example, the contents and the coordinate ranges can be acquired by optical character recognition (OCR) technology, and the categories can be acquired by natural language processing (NLP) technology. OCR and NLP are well-known to those skilled in the art, and thus their principles are not further described herein. The embodiment in FIG. 1 utilizes automatic image processing technology such as OCR, and artificial intelligence technology such as NLP, to automatically interpret each image block in an image and establish various information correlated with each image block. The coordinate ranges corresponding to the image blocks in the mage can be acquired simultaneously while the image blocks are interpreted.

Additionally the image may be an existing image file in a database, or an image created in real time, for example, an image captured in real time by a digital camera or a scanner.

In step 103, the image block with the correlated information in the image is browsed or selected. When the display interface is a touch display interface, for example, the image block with the correlated information in the image can be selected by touching (ex. clicking and etc.) the touch display interface. Moreover, an audio prompt can be provided while browsing or selecting the image block with the correlated information in the image.

In step 105, the correlated information of the selected image block is displayed in a correlated information display area of the display interface. If the information has one or more correlated functional instructions, the functional options of the one or more functional instructions are displayed. In one embodiment of this invention, the correlated information display area can zoom in on the content of the selected image block. The correlated information display area can be closed manually, or closed automatically after a pre-defined interval of time.

In step 107, if one or more correlated functional instructions are available to be executed, at least one of the functional instructions in the functional options is selected and executed.

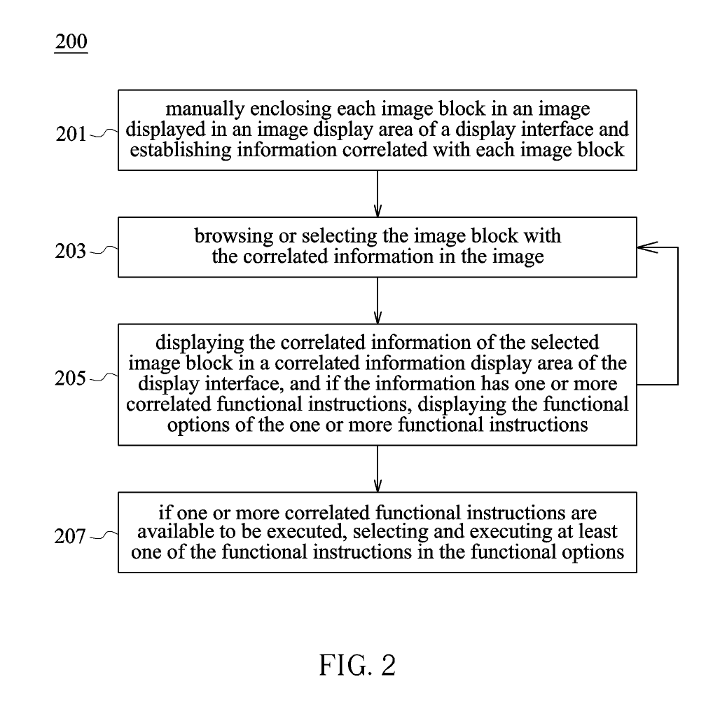

Referring to FIG. 2, flowchart 200 is similar to flowchart 100 depicted in FIG. 1. However, the embodiment of FIG. 2 adopts a manual definition, instead of the automatic image processing technology such as OCR and the artificial intelligence technology such as NLP. Flowchart 200 starts from step 201, in which each image block in an image displayed in an image display area of a display interface is manually enclosed and information correlated with each image block is established. In the embodiment, various information of the image block can be built manually, for example, created by manual input. When the display interface is a touch display interface, the image block in the image can be enclosed by touching the touch display interface. The correlated information of the image block may include contents, categories, and corresponding coordinate ranges. The coordinate ranges corresponding to the image block in the image can be created simultaneously while the manual enclosure is ongoing.

In step 203, the image block with the correlated information in the image is browsed or selected. For instance, the image block with the correlated information in the image can be selected by touching (ex. clicking and etc.) the touch display interface. Alternatively, the image block with the correlated information in the image may be selected (ex. click and etc.) by a cursor controller (ex. a mouse and etc.). Moreover, an audio prompt can be provided while browsing or selecting the image block with the correlated information in the image.

In step 205, the correlated information of the selected image block is displayed in a correlated information display area of the display interface. If the information has one or more correlated functional instructions, the functional options of the one or more functional instructions are displayed. In one embodiment of this invention, the correlated information display area can zoom in on the content of the selected image block. The correlated information display area can be closed manually, or closed automatically after a pre-defined interval of time.

In step 207, if one or more correlated functional instructions are available to be executed, at least one of the functional instructions in the functional options is selected and executed.

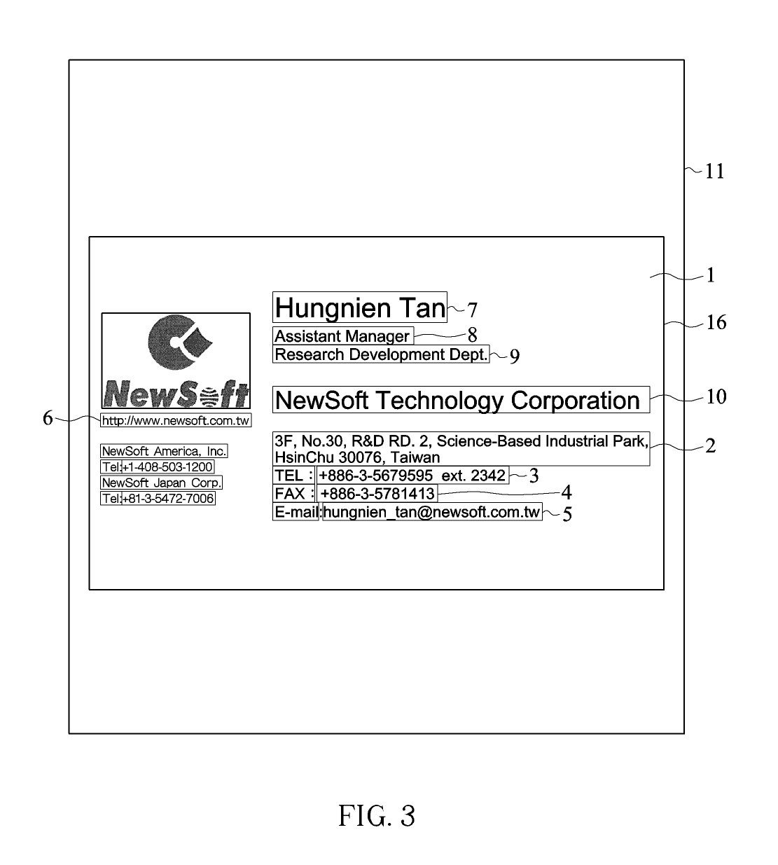

FIG. 3 illustrates an embodiment of this invention applying to business cards. However, it is appreciated that this invention is not limited to the application of business card. First, an image 1 of a business card may be created using devices, such as digital cameras, scanners, and so on. Alternatively, the image of the business card may be an existing image file in a database. Then image blocks of image 1 in an image display area 16 of a display interface 11 are interpreted or manually enclosed, and various information correlated with the image blocks is established. As illustrated in FIG. 3, those image blocks may include: address image block 2, telephone number image block 3, fax number image block 4, e-mail address image block 5, Web address image block 6, name image block 7, job title image block 8, department name image block 9, company name image block 10, company logo image block, and so on. The information of the image blocks may include contents, categories, and corresponding coordinate ranges (ex. the X-coordinate and Y-coordinate of each of the four corners of the image block). In FIG. 3, for example, the categories may include address, telephone number, fax number, e-mail address, Web address, name, job title, department name, company name, company logo, and so on. The contents denote data of the letters and/or numerals of the information.

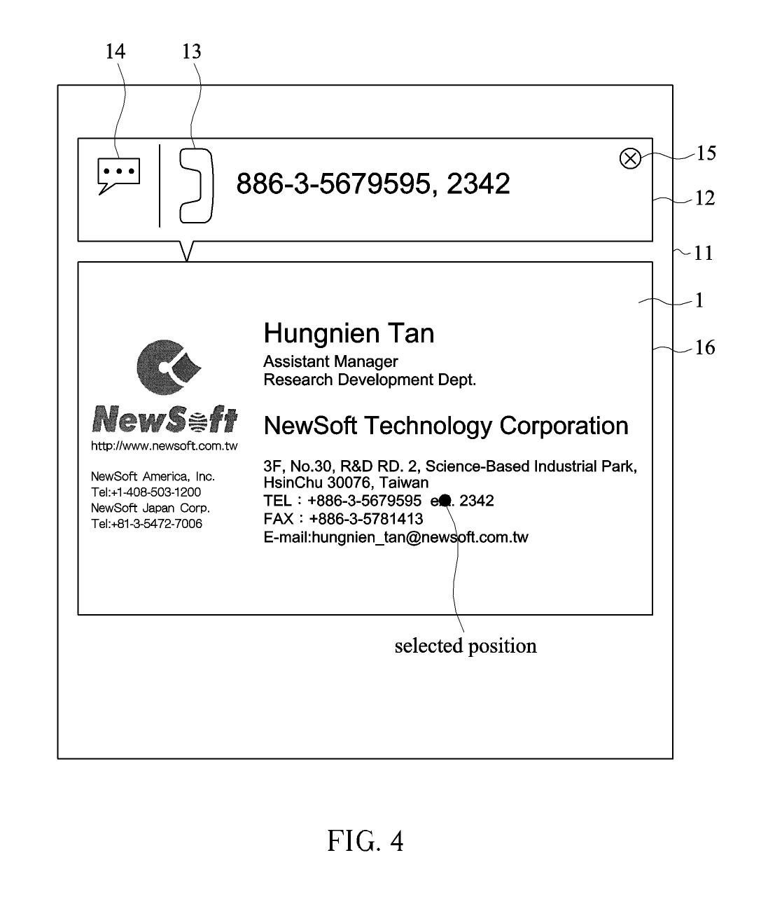

Then, as depicted in FIG. 4, in order to query the telephone number in the business card image, user can pick (i.e., select) the telephone number image block with the correlated information in the image 1 (i.e. the black dot marked as “selected position” in FIG. 4). At that time, a correlated information display area 12 of the display interface 11 appears and shows the correlated information of the selected telephone number image block. The correlated information display area can zoom in on the content of the selected telephone number image block (ex. telephone number). Moreover, if the information of the telephone number image block has one or more correlated functional instructions, the correlated information display area 12 shows the functional options of the one or more functional instructions (ex. phone function 13, short message service (SMS) function 14). User can select and execute at least one of the functional instructions in the functional options (ex. phone function 13, SMS function 14). In FIG. 3 and FIG. 4, for example, the one or more functional instructions can include functions such as map/navigation, phone/SMS, fax, e-mail, Internet browser, and so on.

User can close the correlated information display area 12 by manually clicking image button 15, or the correlated information display area 12 can close automatically after a pre-defined interval of time.

Nevertheless, this invention is not limited to the application of business card. For example, this invention can also be used in warehouse management or other occasions which require browsing and/or executing instructions via information-correlated and instruction-correlated image. Taking the warehouse management as an example, user can acquire an image of a product and interpret or manually enclose image blocks of the image, and then establish correlated information of the image blocks. The information of the image blocks may include the contents and categories of product names, manufacturing batch numbers, suppliers, and etc., as well as the corresponding coordinate ranges. If the information of the image block has one or more functional instructions, the functional options of the one or more functional instructions are displayed, and for example, the one or more functional instructions may be functional instructions for querying product names, manufacturing batch numbers, suppliers and so on. In addition, if the correlated functional instructions described above are available to be executed, user can select and execute at least one of the functional instructions in the functional options. For example, users can execute the functional instruction for querying the manufacturing batch number.

Further, according to yet another embodiment of this invention, a program product with a stored program for browsing and/or executing instructions via information-correlated and instruction-correlated image is provided. A program execution device can perform the method illustrated in FIG. 1 or FIG. 2 after loading the program product. The program execution device may be, but not limited to, a mobile device (ex. mobile phone, personal digital assistant (PDA), and etc.), or a computer (ex. desktop computer, portable computer, and etc.).

While this invention has been described with reference to preferred embodiments thereof, and in terms of the illustrative drawings, various possible modifications, alterations, and equivalent substitution could be conceived of by one skilled in the art without departing from the spirit and the scope of this invention. However, such modifications, alterations, and substitutions still fall within the scope of the claims of this invention.

What is claimed is:

1. A method for browsing and/or executing instructions via information-correlated and instruction-correlated image, comprising:
interpreting each image block in an image displayed in an image display area of a display interface and establishing information correlated with each image block;
browsing or selecting the image block with the correlated information in the image;
displaying the correlated information of the selected image block in a correlated information display area of the display interface, and if the information has one or more correlated functional instructions, displaying the functional options of the one or more functional instructions; and
if one or more correlated functional instructions are available to be executed, selecting and executing at least one of the functional instructions in the functional options.

2. The method of claim 1, wherein the correlated information of the image block includes contents, categories, and corresponding coordinate ranges.

3. The method of claim 2, wherein the contents and the corresponding coordinate ranges of the correlated information are acquired by automatic image processing technology.

4. The method of claim 2, wherein the categories of the correlated information are acquired by artificial intelligence technology.

5. The method of claim 1, wherein an audio prompt is provided while browsing or selecting the image block with the correlated information in the image.

6. The method of claim 1, wherein the correlated information display area zooms in on the content of the selected image block.

7. The method of claim 1, wherein the one or more functional instructions are functional instructions pre-defined or afterward defined on a program execution device.

8. The method of claim 1, wherein the correlated information display area is closed manually, or is closed automatically after a given interval of time.

9. The method of claim 1, wherein the display interface is a touch display interface, and the image block with the correlated information in the image is selected by touching the touch display interface.

10. A method for browsing and/or executing instructions via information-correlated and instruction-correlated image, comprising:
manually enclosing each image block in an image displayed in an image display area of a display interface and establishing information correlated with each image block;
browsing or selecting the image block with the correlated information in the image;
displaying the correlated information of the selected image block in a correlated information display area of the display interface, and if the information has one or more correlated functional instructions, displaying the functional options of the one or more functional instructions; and
if one or more correlated functional instructions are available to be executed, selecting and executing at least one of the functional instructions in the functional options.

11. The method of claim 10, wherein the correlated information of the image block includes contents, categories, and corresponding coordinate ranges.

12. The method of claim 10, wherein the correlated information display area zooms in on the content of the selected image block.

13. The method of claim 10, wherein the correlated information display area is closed manually, or is closed automatically after a given interval of time.

14. The method of claim 10, wherein the display interface is a touch display interface.

15. The method of claim 14, wherein the image block with the correlated information in the image is selected by touching the touch display interface.

16. The method of claim 10, wherein the image block with the correlated information is selected through a cursor controller.

17. The method of claim 10, wherein the one or more functional instructions are functional instructions pre-defined or afterward defined on a program execution device.

18. The method of claim 10, wherein an audio prompt is provided while browsing or selecting the image block with the correlated information in the image.

19. A program product with a stored program for browsing and/or executing instructions via information-correlated and instruction-correlated image, allowing a program execution device to perform the method of claim 1 after loading the program product.

20. The program product of claim 19, wherein the program execution device is a mobile device or a computer.

21. A program product with a stored program for browsing and/or executing instructions via information-correlated and instruction-correlated image, allowing a program execution device to perform the method of claim 10 after loading the program product.

22. The program product of claim 21, wherein the program execution device is a mobile device or a computer.
